(19) United States
(12) Patent Application Publication
(10) Pub. No.: US 2010/0306886 A1
(43) Pub. Date: Dec. 2, 2010

(54) Probe Microscope

(75) Inventors: Motoko HARADA, Hitachi (JP); Kyoko Honbo, Hitachinaka (JP); Katsumi Mabuchi, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/789,796

(22) Filed: May 28, 2010

(30) Foreign Application Priority Data
May 29, 2009 (JP) 2009-129791

(51) Int. Cl. G01Q 30/00

(52) U.S. Cl. 850/8

(57) ABSTRACT

An object of the present invention is to provide a probe microscope that permits qualitative and quantitative evaluation on ions existing near the surface of a sample and permits to detect further simply and easily such as impurities, flaws and corrosion origins existing on the sample in high sensitivity. A probe microscope according to the present invention is provided with a test cell that holds a sample and permits to receive liquid, a probe, a counter electrode, a reference electrode, a drive mechanism that causes the probe to follow the surface of the sample as well as to scan the same, a potential control portion that controls a potential between the probe and the reference electrode and a current measuring portion that measures a current flowing between the probe and the counter electrode, and is characterized in that the material of the probe is constituted by a conductive body containing any of gold or gold alloy, carbon or carbon compound, boron, zinc, lead, tin and mercury.

### CLAIM OF PRIORITY

The present application claims priority from Japanese application serial no. 2009-129791, filed on May 29, 2009, the content of which is hereby incorporated by reference into this application.

### FIELD OF THE INVENTION

The present invention relates to a probe microscope that detects metal ions existing in liquid through controlling electrical potential of a probe and evaluates qualitatively and quantitatively a substance deposited.

### DESCRIPTION OF PRIOR ART

In these days, in order to enhance reliability of electronic and electrical appliances, technology of evaluating corrosion and estimating the corrosion is necessitated. Although objective corrosions of metallic materials are diversified, in particular, in a field of information appliances using many electronic parts, it is indicated that corrosion of micro scale affects the reliability of the appliances in association with their high integration and miniaturization. For this reason, technology using tools that evaluate corrosion in nanometer scale and estimate lifetime is drawing attention. On one hand, in fields of nuclear power and thermal power plants, industrial appliances such as pumps and compressors, automobiles and electric home appliances, corrosion evaluation of the structural materials constituting these is important. However, the size of corrosion analyzed for these structural materials is primarily in an order of millimeter or micrometer, and actually an analysis in nanometer level is performed rarely. It is known that corrosion of these metallic materials constituted of such as steel and stainless steel advances from pitting corrosion as an origin. Even in a structural material of large scale extending to a few hundreds meters, the origin is a small pitting corrosion in an order of nanometer. For this reason, technology of evaluating corrosion process in nanometer scale is demanded even for such structural materials, and the establishment thereof is indispensable.

When clarifying electrochemical reaction process among varieties of reaction processes advancing at electrode/interface, it is necessary and indispensable to know the surface structure of a sample providing the reaction field. As methods of observing such electrochemical reaction process caused in varieties of electrolytic liquids, a few techniques are already reduced into practice. Among these, electrochemical scanning tunneling microscope (EC-STM) applying STM is known.

On one hand, like the EC-STM, as a device that is able to measure the electrochemical reaction process in electrolytes a device called as electrochemical atomic force microscope (EC-AFM) is known (for example, disclosed in JP-A-2007-205850).

### SUMMARY OF THE INVENTION

Technical development of a scanning probe microscope (SPM) represented by a scanning tunneling microscope (STM) and an atomic force microscope (AFM) is remarkable, and its applicability even in liquid other than such as in atmosphere and in vacuum is drawing an attention. Since varieties of reaction materials can be caused solved into solvent in liquid and the chemical reaction on the surface of an electrode disposed in the liquid can be traced at the site, the technology of the electrochemical scanning probe microscope (EC-SPM) is very important. However, in conventional electrochemical scanning probe microscopes reported such as in the above JP-A-2007-205850, the substrate surface, namely, the sample has to be connected to an electrochemical device. However, when connecting the sample to the electrochemical device and causing the sample itself to react, there arises a problem that qualitative and quantitative analysis on ions existing near the surface of the sample cannot be performed correctly.

In view of the problem of the conventional art, an object of the present invention is to provide a probe microscope that permits qualitative and quantitative evaluation on ions existing near the surface of a sample and permits to detect further simply and easily such as impurities, flaws and corrosion origins existing on the sample in high sensitivity.

In the present invention, through immersing a sample in liquid of varieties of compositions, impurities existing on the surface of the sample are caused eluted. Under a condition that a probe and a reference electrode are immersed in solution and the distance between the probe and the sample is held in a predetermined interval, the kind and density of the ions diffusing from the sample are detected by making use of the probe. The detection of the kind and density of the ions is performed by detecting a reducing current through scanning the potential between the probe and the reference electrode and by analyzing qualitatively and quantitatively the ions from a current and potential curve. More specifically, from metal deposition potential based on the potential at the detected peak current, the detected atom is specified and from the current value, the quantity of the detected atom is determined. Further, under the principle of the scanning tunneling microscope or the atomic force microscope, when a predetermined area on the sample is scanned with the probe and when uneven configuration of the sample is measured, defect portions of the sample are imaged and it is possible to determine from which portions the metallic ions are eluted. As a result, the kind and density of ions dissolved in the liquid can be measured under a condition of not causing any electrochemical change on the sample.

Although such as platinum and platinum alloy have been primarily used for a probe of a probe microscope, it was proved that there is an inherent problem in the use of such metals when the measurement principle of the present invention is used. More specifically, when probe potential is scanned toward the side of negative potential beyond from a predetermined potential, protons in the solution are reduced to generate hydrogen, and since a reducing current due to such hydrogen is detected at the same time, it becomes sometimes difficult to specify the metallic ions of detection object. When platinum is used, since a potential window (a region where the current is substantially zero) is narrow and is about 0.3V, the width of the potential window cannot be said sufficient for detecting varieties of metallic ions. In order to perform the detection in further high sensitivity by making use of this measurement principle, the material of the probe becomes important, and as the materials for constituting the probe, it is preferable to use a conductive body containing any of gold or gold alloy, carbon or carbon compound, boron, zinc, lead, tin and mercury. Further, the probe is desirable to be constituted by a conductive body having a potential window at the side of negative potential of which width is wider than that of platinum or a conductive body having larger hydrogen over voltage than that of platinum. Through using such probe, generation of hydrogen is suppressed when compared with an instance where such as platinum and platinum alloy are used, and detection in further high sensitivity can be realized.

A probe microscope according to the present invention is provided with a test cell that holds a sample and permits to receive liquid, a probe, a counter electrode, a reference electrode, a drive mechanism that causes the probe to follow the surface of the sample as well as to scan the same, a potential control portion that controls a potential between the probe and the reference electrode and a current measuring portion that measures a current flowing between the probe and the counter electrode, and is characterized in that the material of the probe is constituted by a conductive body containing any of gold or gold alloy, carbon or carbon compound, boron, zinc, lead, tin and mercury.

### EFFECT OF THE INVENTION

According to the present invention, a probe microscope can be provided that performs simply and easily qualitative and quantitative evaluation such as kind (element) of metallic ions eluted from a sample and an amount of the eluate in high sensitivity. Thereby, such as impurities, flaws and corrosion origins existing on the sample can be easily evaluated.

### BRIEF DESCRIPTION OF THE ACCOMPANYING DRAWINGS

FIG. 1 is a constitutional diagram of an atomic force microscope (AFM) of the present invention.

FIG. 2 is a constitutional diagram of a scanning tunneling microscope (STM) of the present invention.

FIG. 3 is a measurement result of cyclic voltammetry when Au electrode is used.

FIG. 4 is a measurement result of cyclic voltammetry when Pt electrode is used.

### DETAILED DESCRIPTION OF PREFERRED EMBODIMENTS

The present inventors studied to observe eluting impurities in a sample while immersing the sample in the liquid. In particular, if such impurities in the liquid can be detected simply and easily in high sensitivity, whether or not impurities due to sample existing in the liquid can be detected singularly, and through investigating the corrosion behavior of the sample, the detailed characteristics of the sample can be recognized. As a result, the present invention can be used as an inspection method and an analysis tool, for example, for such as semiconductor chips and nuclear power materials. Further, as a result, the present invention can contribute to further high density integration and high reliability of devices.

The probe microscope according to the present invention includes a configuration measurement mode and ion measurement mode. In the configuration measurement mode, a configuration of a sample is measured according to the principle of atomic force microscope or the principle of scanning tunneling microscope. The atmosphere when measuring the configuration of the sample can be even in air, even in vacuum or even in atmospheric gases such as nitrogen, argon and other gases as well as can be even in high humidity, even in high temperature, even in low temperature or even in liquid. As the measurement in liquid, the combinations enumerated in the followings can be possible. Corrosion advancing degrees of housings for power generation plants and electric home appliances are measured in salt water. Defect generation degrees of such as chips and wafers provided with microscopic wirings are measured in varieties of liquids used in such as in the manufacturing processes, for example, such as in plating liquid, in chemical and mechanical polishing liquid (CMP slurry liquid) and in washing liquids used in varieties of washing processes. From the configuration information obtained in such instances, specific positions, namely, portions such as defects, flaws, holes, pits and protrusions are selected.

Now, the description will move to the ion measuring mode, wherein a probe, a sample, a counter electrode and a reference electrode are arranged in liquid, the liquid such as acid, alkali or salt water is introduced over the surface of the sample, the probe is fixed at a position in the liquid near the surface thereof while setting arbitrarily the distance from the sample, and the kind and density of the ions existing there are detected. The reference electrode is an electrode that represents a reference potential when applying a potential to other electrodes, for example, such as the sample and the probe, in that an electrode having no variable potential. The counter electrode is an acting electrode that causes oxidation and reduction reaction while paring, for example, with such as the sample and the probe, and the potential thereof is variable. Accordingly, the counter electrode and the reference electrode cannot exchange their roles. More specifically, under a condition that the potential of the sample with respect to that of the reference electrode is not controlled, the potential or the current of the probe with respect to that of the reference electrode is controlled variably. When the potential is caused scanned toward the side of negative potential, metallic ions are reduced, and the same are deposited on the electrode. According to a current and potential curve obtained when metals are deposited, the deposition of metals appears at the cathode side in peak. Since the peak positions at this moment, in that the deposition potentials of metals are inherent to materials, kind of the metal can be specified by reading the deposition potential of the metal. Namely, by making use of this method the kind of metallic ions existing in the liquid can be clarified. Further, from the magnitude of the peak when a metal deposits, the density of the metallic ions dissolved in the liquid can be determined. As a result, the kind of ions dissolved in the liquid and the density thereof can be measured without causing any electrochemical change on the sample. Thereby, such as impurities contained in structural materials, electronic parts and materials used therefor, defects existing on surfaces thereof and corrosion origins can be evaluated. Further, mutual actions between liquid composition and the sample surface, namely, magnitudes of such reactivity, solubility and corrosivity can be judged.

When measuring ions, for example, by variably controlling only the potential of the probe with respect to the reference electrode, a current flowing between the probe and the counter electrode is electrochemically measured, and the values of the detected current are indicated in graphs or in images. The control methods include such as a sweep method in which the potential is varied with a constant speed, a step method in which the potential is varied in stepwise with a constant time interval and a pulse method in which the potential is applied instantaneously. The distance between the sample and the probe is controlled to be constant. Through detecting a peak of the current values, the potential at this moment is determined. Since the peak potential varies depending on kinds of ions, the kind of the ions can be specified thereby. When impurities are mixed in the sample, a peak due to the impurities is observed. Further, when there exist such as defects and corrosions in the sample, for example, in the case of copper wirings, since copper ions are likely caused from these portions, a peak due to the wiring material is detected. In the present invention, all of generally known electrochemical measurement methods can be applied. Other than the previously mentioned measurement method in which only the potential is variably controlled, varieties of measurement methods such as a constant potential method, cyclic voltamonogram and a chronopotentiometry can be applied.

The ion detection methods include a method in which the potential of the probe with respect to the reference electrode is caused scanned toward positive side with respect to a natural potential so as to oxidize ions on the probe and another method in which the potential of the probe with respect to the reference electrode is caused scanned toward negative side with respect to a natural potential so as to reduce ions on the probe. In the oxidation method, when oxidizing ions, since an oxidation current flows between the probe and the counter electrode, the kind of the ions is determined from the potential of the probe with respect to the reference electrode at this moment, and the density of the ions is determined from the magnitude of the oxidation current. In the reduction method, when reducing ions, since a reduction current flows between the probe and the counter electrode, the kind of the ions is determined from the potential of the probe with respect to the reference electrode at this moment, and the density of the ions is determined from the magnitude of the reduction current.

In the present invention, it is possible to obtain in liquid a signal representing the configuration of the surface of the sample and signals for detecting the kind of ions and/or the density of ions at the same time. In order to obtain the signals for detecting the kind and/or the density of ions existing in the liquid after obtaining the signal representing the configuration, it is preferable to retreat the probe from the surface of the sample by a distance of from more than 20 nm to less than 10 μm. When the distance is less than 20 nm, it is not desirable because a tunneling current flows between the surface of the sample and the probe. Further, when the distance is more than 10 μm, it is not desirable because not only the ions diffused from the specific position on the surface of the sample but also ions diffused from the circumference thereof are contained.

Such measurement shows a feature in which the analysis can be carried out while comparing with the configuration of the surface of the sample. Namely, through measurement of the configuration, when variations of configuration such as defects and unevenness are found out, an analysis can be carried out whether or not ions dissolved into the liquid are detected at the portion where such variation of configuration is found out. Thereby, the cause-effect relationship between the configuration and the dissolved ions is clarified.

Herein below, embodiments of probe microscopes according to the present invention will be explained in detail by making use of the drawings.

### Embodiment 1

### An Example when AFM is Applied

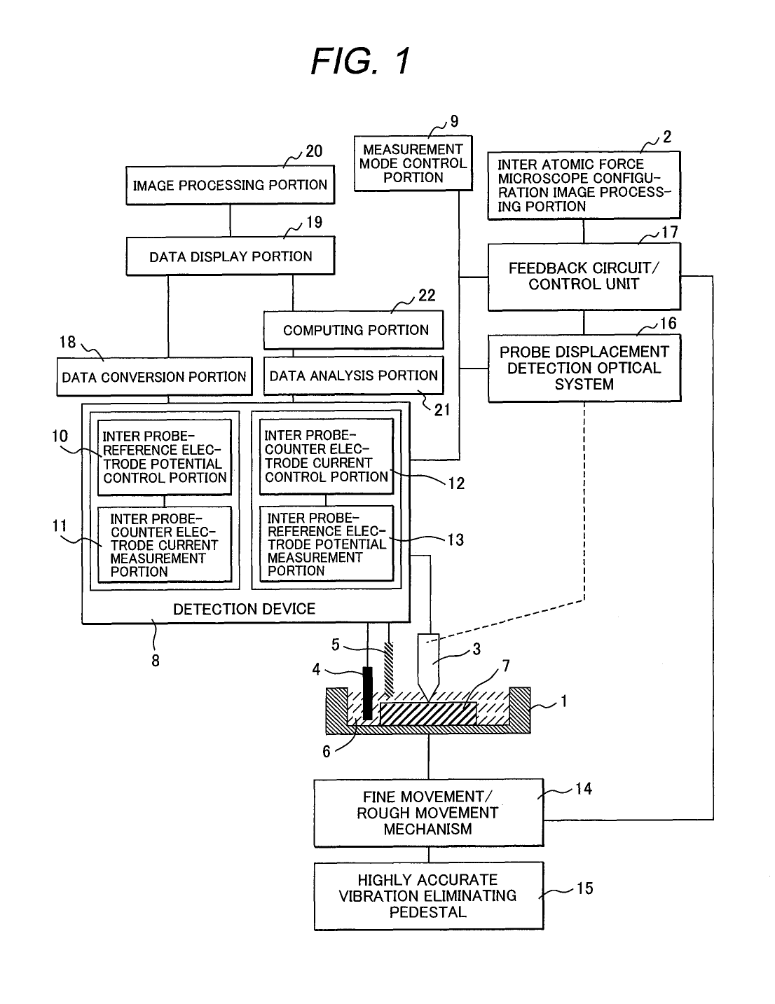

In the present embodiment, an example of a probe microscope will be explained in which a sample is observed by making use of primarily a mechanism of an atomic force microscope (AFM). FIG. 1 is a schematic constitutional diagram of a probe microscope according to the present embodiment.

A device of the present embodiment includes a test cell 1 and a moving mechanism 14 for moving the position of the test cell 1, and a probe 3, a counter electrode 4 and a reference electrode 5 are provided so as to position respectively within the test cell 1. The moving mechanism 14 can effect both rough movement that varies greatly the position of the test cell 1 and fine movement for performing fine adjustment thereof. The probe 3, the counter electrode 4 and the reference electrode 5 are disposed in such a manner that when liquid 6 is poured in the test cell 1, the same are immersed under the liquid 6.

A sample 7 representing an inspection object such as defects and impurities is received in the test cell 1. The sample 7 can be fixed to the test cell 1 by means of such as an O-ring. The probe 3, the counter electrode and the reference electrode 5 are connected to a detection device 8, but the sample 7 is not connected thereto. The detection device 8 is a device that detects, when one of potential and current is varied, the follow-up of the other. A measurement mode control portion 9 controlling switching of the measurement modes automatically effects the switching between the configuration measurement mode and the ion measurement mode and can perform both the configuration measurement and the impurity measurement. The measurement mode control portion 9 is designed to permit a feedback control to the moving mechanism 14 for controlling the distance between the sample 7 and the probe 3 constant in respective modes.

The detection device 8 is provided with a potential control portion 10 that controls the potential between the probe and the reference electrode 5 and a current measurement portion 11 for detecting the current flowing between the probe 3 and the counter electrode 4. As the potential control method, any of chronoamperometry method that continuously keeps the potential under a constant condition (also called as constant potential method) and cyclic voltammetry method that scans the potential with a constant speed, and also other control methods can be used. Further, the detection device 8 is further provided with a current control portion 12 for controlling the current flowing between the probe 3 and the counter electrode 4 and a potential measurement portion 13 that measure the potential between the probe 3 and the reference electrode 5.

As the materials constituting the probe 3, a conductive body having a potential window at the side of negative potential of which width is wider than that of platinum or a conductive body having larger hydrogen over voltage than that of platinum is desirable. As such conductive body, a conductive body containing any of gold or gold alloy, carbon or carbon compound, boron, zinc, lead, tin and mercury can be used. Further, the probe may be constituted by coating the above mentioned conductive body on the surface of substrates such as Pt, PtIr, Si and SiN. Thereby, generation of hydrogen due to reduction of protons existing in the solution can be suppressed. Further, when bubbles are generated from the acting electrode due to hydrogen generation, and in a case where the inter electrode distance is close, bubbles of one electrode tend to be adsorbed to the other electrode. When the hydrogen bubbles have been adhered to the probe, it becomes difficult to observe the deposition phenomenon of the metallic ions. For this reason, in view of the volume of the hydrogen bubbles, it is desirable to set the distances between the three electrodes of the probe, the counter electrode and the acting electrode to be more than 5 mm for limiting the possible adhesion of generated hydrogen bubbles to the other electrodes. Thereby, even when hydrogen is generated, reduction of the metallic ion detection accuracy can be suppressed.

The test cell 1 is mounted on the fine movement/rough movement mechanism 14. The fine movement/rough movement mechanism 14 is provided with a rough movement mechanism in Z axis direction that causes to approach the probe 3 to the sample 7 from the state where the probe 3 is separated away from the sample 7, and an XYZ fine movement mechanism that permits fine relative movement between the sample 7 and the probe 3 in horizontal (XY) and vertical (Z) directions. The fine movement/rough movement mechanism 14 is disposed on a highly accurate vibration eliminating pedestal 15 so as to eliminate vibrations from the outside.

In the configuration measurement mode, the test cell 1 is moved by the fine movement/rough movement mechanism 14 so that the probe 3 comes close to the sample 7. According to the principle of the inter atomic force microscope, the probe 3 is caused to come close to the surface of the sample 7, the mutual acting force (inter atomic force) between the probe 3 and the sample 7 is detected from a displacement of the probe 3, and by continuing the scanning while holding the same constant and by keeping the distance between the probe 3 and the sample 7 constant, the variation of the configuration is measured.

A probe displacement detecting optical system 16 is constituted by a light source and a photo detector, an optical axis of detection light generated from the light source is irradiated to the top end portion of the probe 3 or a portion that follows the displacement of the probe 3, and the reflection light thereof is detected by the photo detector. The probe 3 is approximated with the fine movement/rough movement mechanism 14 to the sample 7 in the area where the mutual action between the probe 3 and the sample 7 is possibly caused, and a probe displacement signal based on the reflection light detected by the probe displacement detecting optical system 16 is outputted to a feedback circuit/control unit 17. The feedback circuit/control unit 17 controls the distance between the probe 3 and the sample 7 to be constant with the fine movement/rough movement mechanism 14. The displacement signal and the control signal from the feedback circuit/control unit 17 are data processed in an inter atomic force microscope image processing portion 2 to form a configuration image by the inter atomic force microscope.

In the ion measurement mode, the probe displacement signal based on the reflection light detected by the probe displacement detecting optical system 16 is outputted to the feedback circuit/control unit 17. The feedback circuit/control unit 17 controls the distance between the probe 3 and the sample 7 to be constant with the fine movement/rough movement mechanism 14. The distance between the probe 3 and the sample 7 is fixed constant in a range from more than 20 nm to less than 10 μm.

Based on the signals obtained from the current measurement portion 11, a curved formed by plotting currents with respect to arbitrary potentials as ordinate and time as abscissa, or alternatively, another curved formed by plotting the currents as ordinate and the potentials as abscissa is obtained. A data converting portion 18 is used for obtaining these curves. Further, these curves are displayed in a form of graphs. For the display a data display portion 19 is used. While defining respective measurement positions by the coordinate positions in X and Y axes and indicating the currents with respect to arbitrary potentials in Z axis, a three dimensional image can be obtained. For the imaging, an image processing portion 20 is used.

Based on the signals obtained from the current measurement portion 11, a curved formed by plotting potentials with respect to arbitrary currents as ordinate and time as abscissa, or alternatively, another curved formed by plotting the potentials as ordinate and the currents as abscissa is obtained. The data converting portion 18 is used for obtaining these curves. Further, these curves are displayed in a form of graphs. For the display the data display portion 19 is used. While defining respective measurement positions by the coordinate positions in X and Y axes and indicating the potentials with respect to arbitrary currents in Z axis, a three dimensional image can be obtained. For the imaging, the image processing portion 20 is used.

Based on the signals obtained by such as the current measurement portion 11 and the potential measurement portion 13, the kind of the ions is identified. In a data analysis portion 21, a data base recoding relationships between current and potential with respect to many number of already known ions can be held, and by collating the signals obtained by the measurement with the data base, the kind of the ions can be identified. Accordingly, with regard to ions of which detection is expected, electrochemical data measured and obtained in advance by the present measurement are stored in the data analysis portion 21.

The detection method according to the first embodiment is as follows.

(1) The configuration measurement mode is selected with the measurement mode control portion 9. After obtaining an inter atomic force microscope image with a conventional method, the image is analyzed. At this moment, significant points with regard to configuration such as defect portions, pits and protruding portions have been marked.

(2) The ion measurement mode is selected with the measurement mode control portion 9. The probe 3 is moved to an XY coordinate position marked previously. The distance in Z axis is kept constant in a range from more than 20 nm to less than 10 μm.

(3) Liquid is introduced over the surface of the sample 7. A small amount of liquid to an extent where the top end of the probe 3 immerses in the liquid is sufficient. The combinations of the liquid with sample are not specifically limited. For example, when corrosion of housings such as for automobile parts by seawater is concerned, corrosion advancing degree in saltwater (sodium chloride water solution) is measured. When defects during manufacturing process such as in chips and wafers provided with microscopic wirings are the target problem, defect generation degrees such as in plating liquid, in chemical and mechanical polishing liquid (CMP slurry liquid) and in washing liquids used in varieties of washing processes are measured.

(4) With the potential control portion 10 built-in in the detection device 8, the potential between the probe 3 and the reference electrode 5 is controlled. As the potential control method, any one of conventional methods is appropriately used. For example, in the case of the cyclic voltammetry method in which the potential is scanned with a constant speed, the potential is caused scanned toward negative side from the natural potential between the probe 3 and the reference electrode 5. The current flowing between the probe 3 and the counter electrode 4, namely, reducing current is detected with the current measurement portion 11. A peak potential when this reducing current maximizes and the current value are measured.

(5) In the data converting portion 18, a current and potential curve formed by plotting the current in ordinate and the potential in abscissa is obtained based on the signals obtained at the current measurement portion 11. The data display portion 19 displays the curve in a form of graph.

(6) In the data analysis portion 21, the kind of ions is identified from the peak potential where the reducing current maximizes. A database on plurality of ions presumed possibly existing is stored in advance. The data analysis portion 21 selects an ion having the most near potential while collating the potential obtained during measurement with the database.

(7) In a computing portion 22, the density of the ion is calculated from the peak current value where the reducing current maximizes. A database on plurality of densities for respective ions is stored in advance. In the computing portion 22, a measuring line representing a relationship between density and current value, coefficients inherent to the device and a computation formula for calculating density of ions are determined in advance. The computing portion 22 calculates the density of the ion while collating the current value obtained during measurement with the database.

(8) By moving the probe to the circumference of the XY coordinate position as marked previously, further measurement is performed likely at a plurality of measurement positions.

(9) Through the use of the image processing portion 20, and by defining respective measurement positions as coordinate positions in X and Y axes and indicating the peak potential where the reducing current maximizes in Z axis, a three dimensional image is formed.

(10) Through the use of the image processing portion 20, and by defining respective measurement positions as coordinate positions in X and Y axes and indicating the peak current value where the reducing current maximizes in Z axis, a three dimensional image is formed.

(11) Though the use of the data display portion 19, a curve is displayed that is formed by plotting the densities of the respective ions based on the kinds and densities of the ions in ordinate and the X axis or Y axis coordinate positions of the measurement points in abscissa.

(12) Through the use of the image processing portion 20, an image is formed in which the respective measurement positions are defined by coordinate positions in X and Y axes and the kind of the ions is distinguished by coloring.

(13) Through the use of the image processing portion 20, and by defining respective measurement positions as coordinate positions in X and Y axes and indicating the ion densities in Z axis, a three dimensional image is formed.

Further, the use of the database is not indispensable when detecting metallic ions. In the case of not using the database, when identifying the kind of the ions from the peak potential where the reducing current maximizes, the database is not relied upon. For a plurality of ions possibly existing, when peak potentials where the reducing currents maximize have been measured in advance, and after collating the potential obtained during measurement with the data measured in advance, an ion having the most near potential is selected. Alternatively, such data can be collected from already known documents.

In addition, when calculating the density of ions from the peak current value where the reducing current maximizes, it is sufficient if data on a plurality of densities for respective ions have been measured in advance. For example, it is sufficient if a relationship between the density and the current value is investigated and a computation formula for calculating the ion density is determined. After collating the current value obtained during measurement with the data measured in advance, the density of the ion can be calculated. Alternatively, such data can be collected from already known documents.

Now, effectiveness on detection of metallic ions in liquid based on materials of the probe 3 will be explained. An investigation was actually performed on four kinds of materials in total including Pt of conventional probe material, Au, GC (glassy carbon) and Ni. As the electrochemical measurement method cyclic voltammetry (CV) was applied.

Before investigating with metallic ion water solution, behavior of respective electrodes in blank water solution was studied. For the blank water solution, 0.1 M potassium nitrate (KNO₃) having pH of 5.6˜5.8 was used. The measurement was started from the natural potential and the scanning is moved toward negative potential side in a manner −1.5V→toward positive potential side 1.0V→the natural potential that was determined as one cycle, and such measurement was repeated continuously for five cycles. The scanning speed was set at 500 mVs⁻¹, and hydrogen generation potentials of the respective probe materials were searched. Table 1 shows a relationship between potential window and hydrogen generation potential of the respective probe materials in the 0.1 M potassium nitrate water solution. The potential window referred to herein indicates a region wherein substantially no current flows in the solution containing supporting electrolyte and the metallic ions existing in the solution are detected with sufficient accuracy. The potential window varies depending on the kind of supporting electrolyte, electrode material and solution to be used.

TABLE 1

| | Potential window | Hydrogen generation |
|---|---|---|
| Probe material | (V) | potential (V) |
| Au | −1.2~−0.2 | −1.2 |
| Pt | −0.6~−0.3 | −0.6 |
| GC | −1.5~−1.0 | −1.5 |
| Ni | −0.8~−0.1 | −0.8 |

As shown in Table 1, the hydrogen generation potential depends on the negative side potential of the potential window. With regard to Pt and Ni, the starting potential of hydrogen generation is at the positive potential side in comparison with Au and GC. It is understood difficult to detect metallic ions having deposition potentials toward negative potential side lower than −0.6V with regard to Pt and lower than −0.8V with regard to Ni. Further, since the potential windows of Pt and Ni are narrow as about 0.3V, it is also understood difficult to use the same for detection of metallic ions. The reason of these is based on the following facts. The deposition potential when metallic ions are caused deposited on a probe through reduction depends on standard oxidation and reduction potential of metal. The standard oxidation and reduction potential, and electrode potential with respect to standard hydrogen electrode in half cell reaction formula, Ox₁+ne⁻→Red₁ (Ox₁: oxidant, n: number of electrons, e⁻: electric charge, Red₁: reductant) being under equilibrium condition when assuming that the activities of the oxidant and the reductant as aₒₓ₁ and a_{red1} respectively are given by the following Nernst's equation.

E₁=E⁰₁−0.059/(nF)log(a_{red1}/aₒₓ₁)

(E₁: electrode potential with respect to standard hydrogen electrode, E⁰₁: standard oxidation and reduction potential, n: number of electrons, F: Faraday constant (96500 Cmol⁻¹, a_{red1}: activity of oxidant, aₒₓ₁: activity of reductant)

Herein below, examples of standard oxidation and reduction potentials of respective metals are shown.

Ni²⁺+2e⁻→Ni E/V=−0.257

Fe²⁺+2e⁻→Fe E/V=−0.44

Mn²⁺+2e⁻→Mn E/V=−1.18

Mo³⁺+3e⁻→Mo E/V=−0.2

Cu²⁺+2e⁻→Cu E/V=0.340

Cr³⁺+e⁻→Cr²⁺ E/V=−0.90

Cr²⁺+2e⁻→Cr E/V=−0.424

Although the deposition potential when metallic ions deposit on a probe through reduction varies depending on the kind of liquid (electrolyte), the potential difference of respective metals is constant. For example, when comparing Ni and Cu, their potential difference scatters by 0.6V, therefore, with Pt having potential window of about 0.3V it is impossible to detect two of Ni and Cu. As has been explained above, since the deposition potential scatters depending on metals, it is desirable that the potential window is wide for detecting many kinds of metals.

Accordingly, when Au and GC having a wider potential window than that of Pt at the negative potential side are applied for the probe material, it is considered possible to detect further many kinds of metals with high sensitivity.

A result of study on influences of hydrogen generation during a peak current detection at a deposition potential of metallic ions will be explained. In the present study, detection of Ni ions was performed that has the deposition potential of −0.9V in 0.1 M KNO₃ water solution. As the probe material, Pt and Au were used.

For the purpose of unifying pH of blank water solution and water solution containing metallic ions, Ni ions were introduced from nickel sulfate hydrate. As the measurement method, CV as mentioned above was used, the measurement was started from the natural potential and the scanning is moved toward negative potential side in a manner −1.0V→toward positive potential side 0.5V→the natural potential that was defined as one cycle, and such measurement were repeated continuously for five cycles. The scanning speed was set at 20 mVs⁻¹. Since the hydrogen generation potential of Pt probe is −0.6V, hydrogen is generated at the deposition potential of Ni ions. On one hand, since the hydrogen generation potential of Au probe is −1.2V, hydrogen is not generated at the deposition potential of Ni ions.

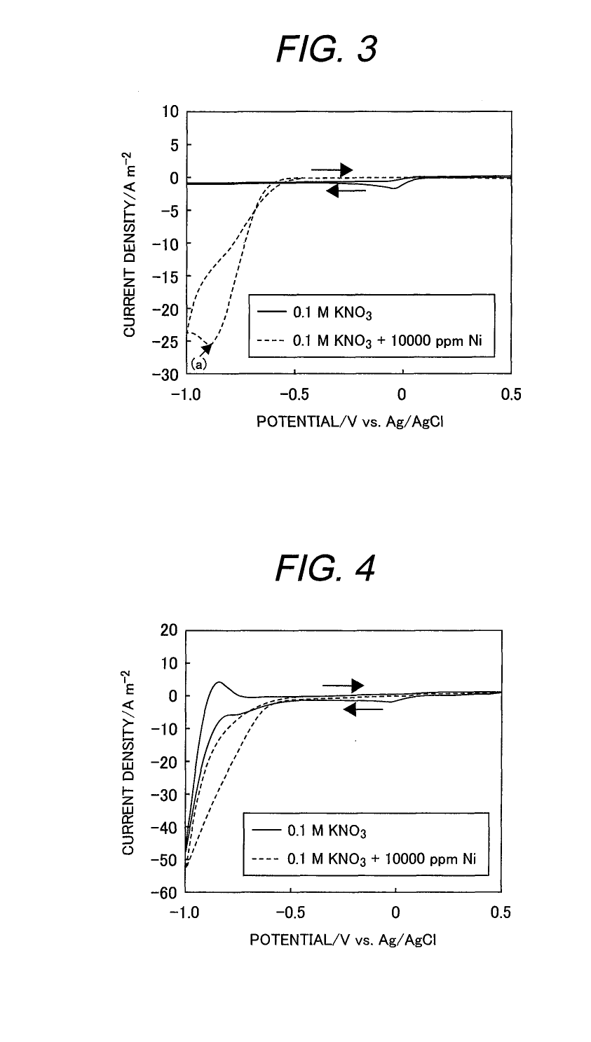

FIGS. 3 and 4 show electrochemical behaviors of Au and Pt probes in blank (0.1 M potassium nitrate water solution) and water solution containing metallic ions (prepared by dissolving 10000 ppm Ni in blank water solution). According to FIG. 3, when Au is used, abroad peak is observed near −0.9V, and the peak is due to the deposition of Ni. On one hand, according to FIG. 4, with the Pt, since the hydrogen generation region and the deposition potential of Ni overlap, no peak cannot be observed. Accordingly, when Au is used for the probe material, it is proved that the peak of Ni can be detected.

As a result, it is understood important that the deposition potential of metallic ions is within the range of the potential window of the probe material used for detecting metallic ions with high sensitivity. As metals of which deposition potential in 0.1 M potassium nitrate water solution overlaps with the potential window of Au, Cu (deposition potential: −0.3V), Fe (deposition potential: −1.08V) and Cr (deposition potential: −1.07V) are enumerated. When a probe of such as AU and GC is used in 0.1 M KNO₃ water solution, varieties of metallic ions such as Ni, Fe, Ct, Cu and Mo can be detected.

Further, as the hydrogen over voltage increases, the hydrogen generation potential tends to shift toward negative potential side. For this reason, it is desirable to select materials having large hydrogen over voltage as the probe material. An example of tendency of hydrogen over voltages of varieties of metals in 0.1 M potassium nitrate water solution is as Hg>Sn>Zn>Pb>Cu>Au>Fe>Ni>Pt. For the detection of ions such as Ni and Fe that are very important in connection with metal corrosion, it is desirable to use materials having hydrogen over voltage of equal to or more than that of Au.

Herein above, although an example in which 0.1 M potassium nitrate water solution was used has been explained, since Au and GC have a wider potential window than that of Pt at the negative potential side, the same advantage as above can be obtained even in other water solutions. Further, like Au, since other probe materials such as gold alloy, carbon or carbon compound, boron, zinc, lead, tin and mercury also have a large hydrogen over voltage and a wide potential window, variety kinds of metallic ions can be detected therewith.

### Embodiment 2

### An Example when STM is Applied

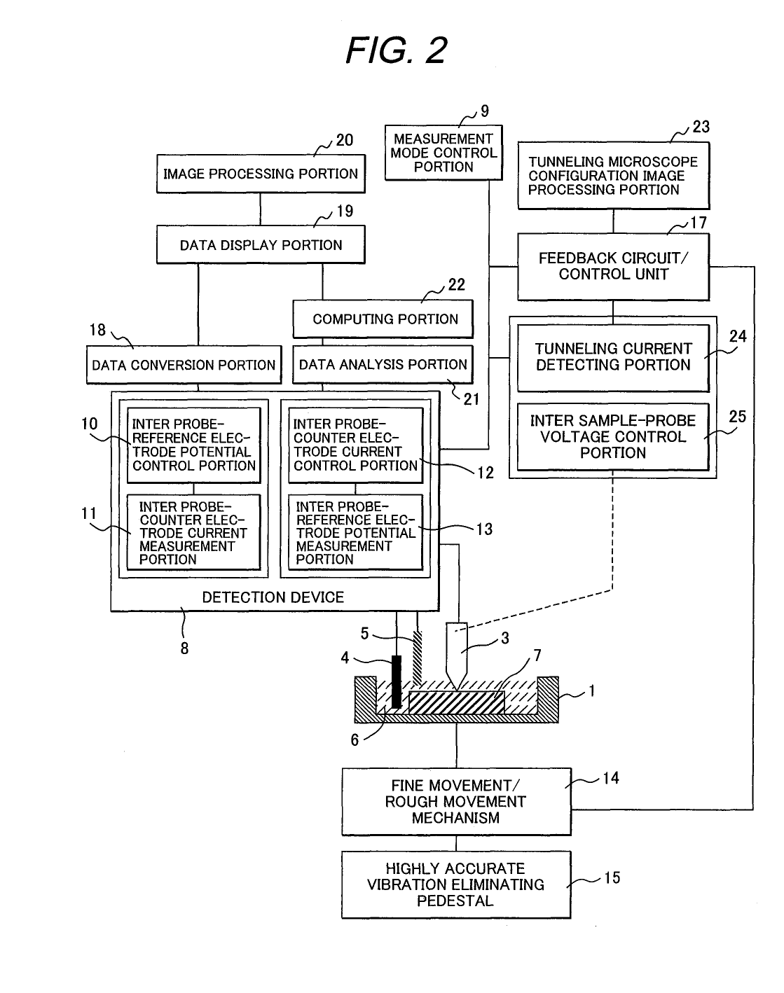

In the present embodiment, another example of a probe microscope will be explained in which a sample is observed by making use of primarily a mechanism of a scanning tunneling microscope (STM). FIG. 2 is a schematic constitutional diagram of a probe microscope according to the present embodiment.

A different point of the present embodiment from embodiment 1 is that in place of the probe displacement detection optical system 16 a tunneling current detection portion 24 and an inter sample-probe voltage control portion 25 are provided.

In the configuration measurement mode with the present probe microscope, through moving the test cell 1 with the fine movement/rough movement mechanism 14, the probe 3 and the sample 7 are approximated each other. According to the principle of the scanning tunneling microscope the probe 3 is approximated to the sample 7, with the inter sample-probe voltage control portion 25 a voltage is applied between the sample 7 and the probe 3, a tunneling current is detected, and the fine movement/rough movement mechanism 14 is feedback controlled by the feedback circuit/control unit 17 so that the tunneling current is maintained constant. The tunneling current signal from the tunneling current detection portion 24 and the control signal from the feedback circuit/control unit 17 are data processed by a tunneling microscope image processing portion 23, and a configuration image by the tunneling microscope is obtained.

The device constitution and the detection method during the ion measurement mode in the present embodiment are the same as those in embodiment 1.

In the embodiments 1 and 2, for detecting metallic ions, a method of controlling primarily the potential between the probe 3 and the reference electrode 5 has been explained, however, it is possible to detect metallic ions by controlling the current between the probe 3 and the reference electrode 5 by making use of the inter probe-reference electrode current control portion 12 as shown in FIGS. 1 and 2 and by detecting the potential with the inter probe-reference electrode potential measurement portion 13. In this instance, by applying the above mentioned probe materials that can suppress hydrogen generation, the detection sensitivity can be enhanced.

1. A probe microscope provided with a test cell that holds a sample and permits to receive liquid, a probe, a counter electrode, a reference electrode, a drive mechanism that causes the probe to follow the surface of the sample as well as to scan the same, a potential control portion that controls a potential between the probe and the reference electrode and a current measuring portion that measures a current flowing between the probe and the counter electrode, characterized in that the probe is constituted by a conductive body having a wider potential window than that of platinum at the negative potential side.

2. A probe microscope according to claim 1 characterized in that the probe is constituted by a conductive body having a larger hydrogen over voltage than that of platinum.

3. A probe microscope according to claim 2 characterized in that the probe is constituted by a conductive body containing any of gold or gold alloy, carbon or carbon compound, boron, zinc, lead, tin and mercury.

4. A probe microscope according to claim 1 characterized in that the potential between the probe and the reference electrode is controlled by the potential control portion, the current flowing between the probe and the counter electrode is measured by the current measurement portion, and the kind of the ions in the liquid is detected from a potential where the current measured shows a peak.

5. A probe microscope according to claim 4 characterized in that the density of the ions is determined by the magnitude of the current that shows the peak.

6. A probe microscope provided with a test cell that holds a sample and permits to receive liquid, a probe, a counter electrode, a reference electrode, a drive mechanism that causes the probe to follow the surface of the sample as well as to scan the same, a potential control portion that controls a potential between the probe and the reference electrode and a current measuring portion that measures a current flowing between the probe and the counter electrode, characterized in that the material of the probe is constituted by a conductive body containing any of gold or gold alloy, carbon or carbon compound, boron, zinc, lead, tin and mercury.

7. A probe microscope according to claim 6 characterized in that the potential between the probe and the reference electrode is controlled by the potential control portion, the current flowing between the probe and the counter electrode is measured by the current measurement portion, and the kind of the ions in the liquid is detected from a potential where the current measured shows a peak.

8. A probe microscope according to claim 7 characterized in that the density of the ions is determined by the magnitude of the current that shows the peak.
